(19) United States
(12) Patent Application Publication
(10) Pub. No.: US 2026/0132072 A1
(43) Pub. Date: May 14, 2026

(54) OPTICAL GLASS, GLASS PREFORM, OPTICAL ELEMENT, AND OPTICAL INSTRUMENT

(71) Applicant: CDGM GLASS CO., LTD, Chengdu (CN)

(72) Inventors: Bo KUANG, Chengdu (CN); Bo HE, Chengdu (CN); Famao YANG, Chengdu (CN)

(73) Assignee: CDGM GLASS CO., LTD, Chengdu (CN)

(21) Appl. No.: 19/440,937

(22) Filed: Jan. 6, 2026

Related U.S. Application Data
(63) Continuation of application No. PCT/CN2024/098006, filed on Jun. 7, 2024.

(30) Foreign Application Priority Data
Sep. 7, 2023 (CN) 202311149924.3

(51) Int. Cl. C03C 3/21; C03C 3/064; C03C 3/068

(52) U.S. Cl. CPC C03C 3/21; C03C 3/064; C03C 3/068

(57) ABSTRACT

An optical glass, including following components in percentage by weight: P₂O₅: 20-35%; Nb₂O₅: 37-55%; TiO₂: 1-12%; BaO: 4-19%; and Na₂O: 0.5-14%. Through reasonable component design, this optical glass is free of environmentally harmful components such as PbO, and simultaneously exhibits high refractive index and high dispersion properties, satisfying the requirements for use in high-performance optical instruments.

### CROSS-REFERENCE TO RELATED APPLICATIONS

This application is a continuation of International Application No. PCT/CN2024/098006, filed on Jun. 7, 2024, which claims priority to Chinese Patent Application No. 202311149924.3, filed on Sep. 7, 2023. The disclosures of the above-mentioned applications are hereby incorporated by reference in their entireties.

### TECHNICAL FIELD

This application relates to the field of optical glass, and in particular to an optical glass with a refractive index of 1.82-1.89 and an Abbe number of 18-26, glass preforms, optical elements, and optical instruments made therefrom.

### BACKGROUND

In recent years, the digitalization and the image and video high-definition technology of optical instruments have been developing rapidly. In particular, the high definition of images and videos is very prominent in optical instruments such as digital cameras, video cameras, and projectors. Simultaneously, in the optical systems incorporated in these optical instruments, efforts are made to reduce the number of optical elements such as lenses and prisms to achieve weight reduction and miniaturization. Under the same radius of curvature, glass with a higher refractive index provides a larger imaging field of view, which is beneficial for reducing the number of optical elements in the optical instrument. With the trend towards miniaturization of optical instruments, the demand for high-refractive-index, high-dispersion optical glass with a refractive index of 1.82-1.89 and an Abbe number of 18-26 is becoming increasingly evident.

Chinese Patent Publications CN1186279C and CN1229293C respectively disclose high-refractive-index, high-dispersion optical glasses, both of which contain a large amount of PbO. PbO is harmful to the environment, and the high density of the glass is not unfavorable to the lightweight requirements of optical glass. Chinese Patent Applications CN102471130A, CN101932532A, and CN101289275A respectively disclose high-refractive-index, high-dispersion optical glasses, each containing a large amount of SiO₂, whose melting properties need improvement.

### SUMMARY

The technical problem to be solved by this application is to provide an optical glass having a refractive index of 1.82 to 1.89 and an Abbe number of 18 to 26, while meeting environmental protection requirements.

To solve the above technical problem, the present application adopts the following technical solutions.

The optical glass includes following components in percentage by weight: 20-35% of P₂O₅, 37-55% of Nb₂O₅, 1-12% of TiO₂, 4-19% of BaO, and 0.5-14% of Na₂O.

Furthermore, the optical glass further includes following components in percentage by weight: 0-8% of CaO; and/or 0-5% of MgO; and/or 0-8% of SrO; and/or 0-5% of ZnO; and/or 0-5% of Li₂O; and/or 0-5% of K₂O; and/or 0-5% of Ln₂O₃; and/or 0-5% of SiO₂; and/or 0-5% of B₂O₃; and/or 0-3% of Al₂O₃; and/or 0-3% of WO₃; and/or 0-5% of ZrO₂; and/or 0-3% of Bi₂O₃; and/or 0-1% of a fining agent; wherein the Ln₂O₃ is one or more selected from La₂O₃, Gd₂O₃, Y₂O₃, Yb₂O₃, and Lu₂O₃, and the fining agent is one or more selected from Sb₂O₃, SnO₂, and CeO₂.

The optical glass includes following components in percentage by weight: 20-35% of P₂O₅, 37-55% of Nb₂O₅, 1-12% of TiO₂, 4-19% of BaO, 0.5-14% of Na₂O, 0-8% of CaO, 0-5% of MgO, 0-8% of SrO, 0-5% of ZnO, 0-5% of Li₂O, 0-5% of K₂O, 0-5% of Ln₂O₃, 0-5% of SiO₂, 0-5% of B₂O₃, 0-3% of Al₂O₃, 0-3% of WO₃, 0-5% of ZrO₂, 0-3% of Bi₂O₃, and 0-1% of a fining agent, wherein the Ln₂O₃ is one or more selected from La₂O₃, Gd₂O₃, Y₂O₃, Yb₂O₃, and Lu₂O₃, and the fining agent is one or more selected from Sb₂O₃, SnO₂, and CeO₂.

Furthermore, the optical glass has components expressed in percentage by weight, wherein a ratio of (ZnO+Li₂O+K₂O+WO₃+B₂O₃+Bi₂O₃) to SrO is 2.0 or less, preferably 1.5 or less, more preferably 1.0 or less, and further preferably 0.5 or less.

Further, the optical glass has components expressed in percentage by weight, wherein a ratio of (Li₂O+B₂O₃+Bi₂O₃) to TiO₂ is 1.0 or less, preferably 0.8 or less, more preferably 0.5 or less, and further preferably 0.2 or less.

Further, the optical glass has components expressed in percentage by weight, wherein a ratio of SrO to TiO₂ is 0.01 to 5.0, preferably 0.01 to 2.0, more preferably 0.05 to 1.0, and further preferably 0.1 to 0.7.

Further, the optical glass has components expressed in percentage by weight, wherein a ratio of BaO to (Na₂O+K₂O+TiO₂) is 0.4 to 5.0, preferably 0.5 to 3.0, more preferably 0.6 to 2.5, and further preferably 0.7 to 1.5.

Further, the optical glass has components expressed in percentage by weight, wherein a ratio of Nb₂O₅ to P₂O₅ is 1.3 to 2.7, preferably 1.4 to 2.5, more preferably 1.5 to 2.2, and further preferably 1.6 to 2.0.

Further, the optical glass has components expressed in percentage by weight, wherein a ratio of (SiO₂+CaO+ZnO) to SrO is 0.3 to 8.0, preferably 0.5 to 5.0, more preferably 0.6 to 3.0, and further preferably 0.7 to 2.0.

Further, the optical glass has components expressed in percentage by weight, wherein a ratio of (WO₃+ZnO+K₂O+CaO+MgO) to TiO₂ is 2.0 or less, preferably 0.05 to 1.5, more preferably 0.1 to 1.0, and further preferably 0.2 to 0.8.

Further, the optical glass has components expressed in percentage by weight, wherein a ratio of (WO₃+K₂O+TiO₂+B₂O₃) to Nb₂O₅ is 0.03 to 0.4, preferably 0.04 to 0.3, more preferably 0.05 to 0.25, and further preferably 0.06 to 0.15.

Further, the optical glass has components expressed in percentage by weight, wherein a ratio of Na₂O to BaO is 0.05 to 2.0, preferably 0.1 to 1.5, more preferably 0.2 to 1.0, and further preferably 0.4 to 0.9.

Further, the optical glass has components expressed in percentage by weight, wherein a ratio of BaO to P₂O₅ is 0.15 to 0.9, preferably 0.25 to 0.8, more preferably 0.3 to 0.7, and further preferably 0.35 to 0.6.

Further, the optical glass has components expressed in percentage by weight, wherein a ratio of (Li₂O+B₂O₃+TiO₂) to BaO is 0.06 to 2.0, preferably 0.07 to 1.5, more preferably 0.08 to 1.0, and further preferably 0.1 to 0.5.

Further, the optical glass has components expressed in percentage by weight, wherein a ratio of TiO₂ to CaO is 0.4 to 10.0, preferably 0.8 to 8.0, more preferably 1.0 to 6.0, and further preferably 1.2 to 5.0.

Further, the optical glass, components of which expressed in percentage by weight, includes:
P₂O₅: 22-32%, preferably 25-30%; and/or
Nb₂O₅: 41-52%, preferably 43-50%; and/or
TiO₂: 2-10%, preferably 3-7%; and/or
BaO: 6-16.5%, preferably 10-15%; and/or
Na₂O: 2-12%, preferably 5-10%; and/or
CaO: greater than 0% but not more than 6%, preferably 1-4%; and/or
MgO: 0-3%, preferably 0-1%; and/or
SrO: greater than 0% but not more than 5%, preferably 0.5-3%; and/or
ZnO: 0-3%, preferably 0-1%; and/or
Li₂O: 0-3%, preferably 0-1%; and/or
K₂O: 0-3%, preferably 0-1%; and/or
Ln₂O₃: 0-3%, preferably 0-1%; and/or
SiO₂: 0-3%, preferably 0-1%; and/or
B₂O₃: 0-3%, preferably 0-1%; and/or
Al₂O₃: 0-2%, preferably 0-1%; and/or
WO₃: 0-2%, preferably 0-1%; and/or
ZrO₂: 0-2%, preferably 0-1%; and/or
Bi₂O₃: 0-2%, preferably 0-1%; and/or
a fining agent: 0-0.5%, preferably 0-0.1%,
wherein Ln₂O₃ is one or more selected from La₂O₃, Gd₂O₃, Y₂O₃, Yb₂O₃, and Lu₂O₃, and the fining agent is one or more selected from Sb₂O₃, SnO₂, and CeO₂.

Further, the optical glass does not include MgO; and/or does not include ZnO; and/or does not include Li₂O; and/or does not include K₂O; and/or does not include Ln₂O₃; and/or does not include B₂O₃; and/or does not include Al₂O₃; and/or does not include WO₃; and/or does not include ZrO₂; and/or does not include Bi₂O₃; and/or does not include a fining agent, wherein Ln₂O₃ is one or more selected from La₂O₃, Gd₂O₃, Y₂O₃, Yb₂O₃, and Lu₂O₃, and the fining agent is one or more selected from Sb₂O₃, SnO₂, and CeO₂.

Further, the optical glass has a refractive index n_{d} of 1.82-1.89, preferably 1.83-1.88, more preferably 1.84-1.87; and an Abbe number ν_{d} of 18-26, preferably 20-25, more preferably 21-24.

Further, the optical glass has a thermal expansion coefficient α_{100/300° C.} of 100×10⁻⁷/K or less, preferably 95×10⁻⁷/K or less, more preferably 90×10⁻⁷/K or less; and/or an acid resistance stability D_{A} of Class 2 or better, preferably Class 1; and/or a water resistance stability D_{W} of Class 2 or better, preferably Class 1; and/or a relative partial dispersion P_{g,F} of 0.58-0.72, preferably 0.60-0.68, more preferably 0.62-0.65; and/or a relative partial dispersion deviation ΔP_{g,F} of 0.08 or less, preferably 0.005-0.06, more preferably 0.01-0.04; and/or a transition temperature T_{g} of 670° C. or less, preferably 660° C. or less, more preferably 650° C. or less; and/or an abrasion degree f_{A} of 250-290, preferably 260-285, more preferably 265-280; and/or a density ρ of 4.00 g/cm³ or less, preferably 3.90 g/cm³ or less, more preferably 3.80 g/cm³ or less; and/or λ₇₀ of 430 nm or less, preferably 420 nm or less, more preferably 410 nm or less; and/or λ₅ of 400 nm or less, preferably 390 nm or less, more preferably 380 nm or less; and/or a weathering resistance CR of Class 2 or better, preferably Class 1; and/or a Young's modulus E of 8,000×10⁷ Pa or higher, preferably 8,500×10⁷ Pa or higher, more preferably 9,000×10⁷ Pa or higher; and/or a bubble degree of Class A or better, preferably A0 or higher, more preferably A00.

A glass preform is made from the above optical glass.

An optical element is made from the optical glass or from the glass preform.

An optical instrument includes the optical glass or the optical element.

The beneficial effect of the present application is that, through a reasonable composition design, the optical glass of the present application does not include environmentally harmful components such as PbO, while having high refractive index and high dispersion properties, and satisfying the requirements of high-performance optical instruments.

### DETAILED DESCRIPTION OF THE EMBODIMENTS

The embodiments of the optical glass of the present application will be described in detail below. However, the present application is not limited to the embodiments described below and may be implemented with appropriate modifications within the scope of the objectives of the application. Furthermore, portions that would otherwise be repetitive may be omitted as appropriate, but this will not limit the spirit of the application. In the following text, the optical glass of the present application is sometimes referred to simply as “glass.”

### Optical Glass

The range of each component (ingredient) of the optical glass of the present application will be described below. In the present application, unless otherwise specified, a content of each component and a total content are all expressed as weight percentages (wt %), that is, the weight percentage of the content of each component and the total content relative to the total amount of glass material of an oxide-converted composition. Here, the “oxide-converted composition” means that when the oxides, complex salts, and hydroxides used as raw materials for the optical glass of the present application decompose and transform into oxides upon melting, the total amount of such oxides is regarded as 100%.

Unless otherwise specified in specific circumstances, the numerical ranges listed in the present application include upper and lower limits. The expressions “above/or more” and “below/or less” include endpoint values, and all integers and fractions included in the range, and are not limited to the specific values enumerated within the defined ranges. The term “and/or” as used herein is inclusive. For example, “A and/or B” means A alone, B alone, or both A and B.

### Essential Components and Optional Components

P₂O₅ is a network former of the glass of this application. Compared to silicate glass, phosphate glass can melt at a low temperature, which is beneficial for improving the optical transmittance of the glass. If the P₂O₅ content is too high, it is difficult for the glass to obtain a relatively high refractive index. Therefore, the P₂O₅ content in this application is 20-35%, preferably 22-32%, and more preferably 25-30%.

Nb₂O₅ is a high-refractive-index and high-dispersion component that can improve the refractive index and devitrification resistance of the glass, and has the effect of reducing the relative partial dispersion (P_{g,F}) and anomalous partial dispersion value (ΔP_{g,F}) of the glass. In this application, the above effects are achieved by containing more than 37% of Nb₂O₅. Preferably, the lower limit of Nb₂O₅ content is 41%, more preferably 43%. If the Nb₂O₅ content exceeds 55%, the thermal stability and chemical durability of the glass decreases, and the optical transmittance declines. Therefore, an upper limit of the Nb₂O₅ content in this application is 55%, preferably 52%, and more preferably 50%.

In some embodiments, controlling a ratio of Nb₂O₅ content to P₂O₅ content (Nb₂O₅/P₂O₅) within a range of 1.3 to 2.7 can improve the crystallization resistance and chemical durability of the glass, optimize the Young's modulus of the glass, and more easily obtain the desired P_{g,F} value and ΔP_{g,F} value. Therefore, preferably, the Nb₂O₅/P₂O₅ ratio is from 1.3 to 2.7, more preferably from 1.4 to 2.5, further preferably from 1.5 to 2.2, and even more preferably from 1.6 to 2.0.

TiO₂ exhibits high-refractive-index and high-dispersion characteristics and can improve the chemical stability of the glass, as well as adjust the relative partial dispersion (P_{g,F}) and the anomalous partial dispersion value (ΔP_{g,F}). If its content is excessively high, the devitrification resistance and optical transmittance of the glass decrease. Therefore, the TiO₂ content is 1-12%, preferably 2-10%, and more preferably 3-7%.

BaO can improve the devitrification resistance and hardness of the glass and reduce the temperature coefficient of refractive index and the thermal expansion coefficient. In the present application, by incorporating more than 4% of BaO, the above effects can be achieved. The BaO content is preferably 6% or more, and more preferably 10% or more. On the other hand, by limiting the BaO content to 19% or less, a reduction in chemical durability caused by an excessively high BaO content can be prevented. Therefore, the BaO content is 19% or less, preferably 16.5% or less, and more preferably 15% or less.

In some embodiments, by controlling the ratio of BaO content to P₂O₅ content (BaO/P₂O₅) within a range of 0.15 to 0.9, the weather resistance and optical transmittance of the glass can be improved, and the wear resistance can be optimized. Accordingly, the preferred BaO/P₂O₅ ratio is 0.15 to 0.9, more preferably 0.25 to 0.8, further preferably 0.3 to 0.7, and still further preferably 0.35 to 0.6.

CaO helps adjust the optical constants of the glass and improves the processability and weather resistance of the glass. However, if the CaO content is too high, the crystallization resistance of the glass deteriorates. Therefore, the CaO content is 0-8%, preferably greater than 0 but not more than 6%, and more preferably 1-4%.

In some embodiments, by controlling the ratio of the TiO₂ content to the CaO content (TiO₂/CaO) within a range of 0.4-10.0, the thermal expansion coefficient of the glass can be reduced, and the Young's modulus and wear resistance can be optimized. Accordingly, the preferred TiO₂/CaO ratio is 0.4-10.0, more preferably 0.8-8.0, further preferably 1.0-6.0, and still further preferably 1.2-5.0.

SrO can adjust the refractive index and dispersion of the glass. However, if its content is too high, the chemical durability of the glass decreases, and the cost of the glass also increases. Therefore, the SrO content is 0-8%, preferably greater than 0 but not more than 5%, and more preferably 0.5-3%.

In some embodiments, by controlling the ratio of the SrO content to the TiO₂ content (SrO/TiO₂) within a range of 0.01-5.0, the glass can achieve desired P_{g,F} value and ΔP_{g,F} value while improving the Young's modulus and preventing a reduction in optical transmittance. Accordingly, the preferred SrO/TiO₂ ratio is 0.01-5.0, more preferably 0.01-2.0, further preferably 0.05-1.0, and still further preferably 0.1-0.7.

MgO is beneficial for reducing the density and melting temperature of glass, but excessive MgO content makes it difficult to achieve a desired refractive index of glass, and the glass's devitrification resistance and stability decrease. Therefore, the content of MgO is 0-5%, preferably 0-3%, and more preferably 0-1%. In some embodiments, it is further preferred that the glass is free of MgO.

ZnO can lower the transition temperature and melting temperature of glass, improve the chemical durability of the glass, and reduce the high-temperature viscosity. However, if the ZnO content is too high, the devitrification resistance of the glass deteriorates, and devitrification easily occurs due to the excessively low viscosity. Therefore, the content of ZnO in this application is 0-5%, preferably 0-3%, and more preferably 0-1%. In some embodiments, it is further preferred that the glass is free of ZnO.

Li₂O can improve the meltability of the glass and lower the transition temperature. However, if its content is too high, it is difficult to achieve the desired refractive index of the glass, and the chemical durability of the glass deteriorates. Therefore, the content of Li₂O in this application is 0-5%, preferably 0-3%, and more preferably 0-1%. In some embodiments, it is further preferred that the glass is free of Li₂O.

Na₂O can improve the meltability and formability of the glass and optimize the optical transmittance. However, if its content is too high, it is detrimental to the coefficient of thermal expansion and chemical durability of the glass. Therefore, the Na₂O content is 0.5-14%, preferably 2-12%, and more preferably 5-10%.

In some embodiments, controlling the ratio of Na₂O content to BaO content (Na₂O/BaO) within a range of 0.05-2.0 is beneficial for improving the bubble degree of the glass, optimizing the abrasion resistance of the glass, and preventing an increase in the coefficient of thermal expansion. Therefore, Na₂O/BaO is preferably 0.05-2.0, more preferably 0.1-1.5, further preferably 0.2-1.0, and even more preferably 0.4-0.9.

K₂O has the effect of improving the thermal stability and meltability of the glass, but if its content is too high, the devitrification resistance of the glass decreases. Therefore, the K₂O content is 0-5%, preferably 0-3%, and more preferably 0-1%. In some embodiments, it is further preferred that the glass is free of K₂O.

In some embodiments, controlling the ratio of BaO content to the total content of Na₂O, K₂O, and TiO₂ (BaO/(Na₂O+K₂O+TiO₂)) within the range of 0.4 to 5.0, makes it easier to obtain the desired P_{g,F} value and ΔP_{g,F} value for the glass, and prevents an increase in glass density. Therefore, BaO/(Na₂O+K₂O+TiO₂) is preferably 0.4-5.0, and more preferably 0.5-3.0. Furthermore, controlling BaO/(Na₂O+K₂O+TiO₂) within a range of 0.6-2.5 can further optimize the abrasion resistance and bubble degree of the glass. Therefore, BaO/(Na₂O+K₂O+TiO₂) is further preferably 0.6-2.5, and even more preferably 0.7-1.5.

Ln₂O₃ (Ln₂O₃ is one or more of La₂O₃, Gd₂O₃, Y₂O₃, Yb₂O₃, and Lu₂O₃) is a component that increases the refractive index of glass and is an optional component in the optical glass of this application. By controlling the content of Ln₂O₃ to 5% or less, a decrease in the devitrification resistance of the glass can be prevented. Therefore, in this application, the content of Ln₂O₃ is 0-5%, preferably 0-3%, and more preferably 0-1%. In some embodiments, it is further preferred that the glass is free of Ln₂O₃.

In phosphate glass, the inclusion of SiO₂ can make the glass network more compact, enhancing the chemical durability and mechanical strength of the glass. However, the phosphate glass network has poor compatibility with SiO₂, and phase separation and precipitation are likely to occur when the SiO₂ content is too high. Therefore, in this application, the content of SiO₂ is 0-5%, preferably 0-3%, and more preferably 0-1%.

In some embodiments, controlling the ratio of the total content of SiO₂, CaO, and ZnO (SiO₂+CaO+ZnO) to the content of SrO, that is, (SiO₂+CaO+ZnO)/SrO, within the range of 0.3 to 8.0 is beneficial for reducing the coefficient of thermal expansion and density of the glass, and optimizing the climatic resistance of the glass. Therefore, it is preferred that (SiO₂+CaO+ZnO)/SrO is 0.3-8.0, more preferably 0.5-5.0, further preferably 0.6-3.0, and even more preferably 0.7-2.0.

B₂O₃ has the effect of improving the thermal stability and meltability of the glass, but when its content is high, the chemical durability and devitrification resistance of the glass decrease. Therefore, in this application, the content of B₂O₃ is 0-5%, preferably 0-3%, and more preferably 0-1%. In some embodiments, it is further preferred that the glass is free of B₂O₃.

In some embodiments, controlling the ratio of the total content of Li₂O, B₂O₃, and TiO₂ to the content of BaO, that is, (Li₂O+B₂O₃+TiO₂)/BaO, within the range of 0.06 to 2.0 can improve the climatic resistance of the glass, prevent an increase in the transition temperature, and facilitate obtaining the desired P_{g,F} value and ΔP_{g,F} value. Therefore, (Li₂O+B₂O₃+TiO₂)/BaO is preferably 0.06 to 2.0, more preferably 0.07 to 1.5, further more preferably 0.08 to 1.0, and still further more preferably 0.1 to 0.5.

Al₂O₃ can improve the chemical durability of the glass, but when its content exceeds 3%, the meltability and optical transmittance of the glass deteriorate. Therefore, in this application the content of Al₂O₃ is 0-3%, preferably 0-2%, and more preferably 0-1%. In some embodiments, it is further preferred that the glass is free of Al₂O₃.

WO₃ is an optional component capable of adjusting the optical constants and devitrification resistance of the glass; however, when its content is high, the transmittance and crystallization resistance of the glass decrease. Therefore, the content of WO₃ is 0-3%, preferably 0-2%, and more preferably 0-1%. In some embodiments, it is further preferred that the glass is free of WO₃.

In some embodiments, controlling the ratio of the total content of WO₃, ZnO, K₂O, CaO, and MgO to the content of TiO₂, that is, (WO₃+ZnO+K₂O+CaO+MgO)/TiO₂, to be 2.0 or less can increase the bubble degree quality of the glass and optimize its abrasion resistance while reducing the glass transition temperature. Therefore, (WO₃+ZnO+K₂O+CaO+MgO)/TiO₂ is preferably 2.0 or less, more preferably 0.05 to 1.5, even more preferably 0.1 to 1.0, and still even more preferably 0.2 to 0.8.

In some embodiments, controlling the ratio of the total content of WO₃, K₂O, TiO₂, and B₂O₃ to the content of Nb₂O₅, that is, (WO₃+K₂O+TiO₂+B₂O₃)/Nb₂O₅, within the range of 0.03 to 0.4 can reduce the thermal expansion coefficient of the glass and improve its optical transmittance and chemical durability. Therefore, (WO₃+K₂O+TiO₂+B₂O₃)/Nb₂O₅ is preferably 0.03 to 0.4, more preferably 0.04 to 0.3, even more preferably 0.05 to 0.25, and still even more preferably 0.06 to 0.15.

An appropriate amount of ZrO₂ can increase the mechanical strength and hardness of the glass, improve the devitrification resistance of the glass, and adjust the P_{g,F} value and A P_{g,F} value of the glass. However, ZrO₂ is difficult to dissolve in phosphate glass, and excessive amounts can lead to melting difficulties. Therefore, the content of ZrO₂ in this application is 0-3%, preferably 0-2%, and more preferably 0-1%. In some embodiments, it is further preferred that the glass is free of ZrO₂.

Bi₂O₃ can increase the refractive index of the glass, but Bi₂O₃ has a high density, which is unfavorable for lightweight glass design. Therefore, the content of Bi₂O₃ in this application is 0-3%, preferably 0-2%, and more preferably 0-1%. In some embodiments, it is further preferred that the glass is free of Bi₂O₃.

In some embodiments, controlling the ratio of the total content of ZnO, Li₂O, K₂O, WO₃, B₂O₃, and Bi₂O₃ to the content of SrO, that is, (ZnO+Li₂O+K₂O+WO₃+B₂O₃+Bi₂O₃)/SrO, to be 2.0 or less can improve the bubble degree of the glass, optimize the Young's modulus, and prevent a decrease in optical transmittance while maintaining a low thermal expansion coefficient. Therefore, it is preferred that (ZnO+Li₂O+K₂O+WO₃+B₂O₃+Bi₂O₃)/SrO is 2.0 or less, more preferably 1.5 or less, further preferably 1.0 or less, and even more preferably 0.5 or less.

In some embodiments, controlling the ratio of the total content of Li₂O, B₂O₃, and Bi₂O₃ to the content of TiO₂, that is, (Li₂O+B₂O₃+Bi₂O₃)/TiO₂, to be 1.0 or less, is beneficial for reducing the glass density and optimizing its chemical durability, making it easier to achieve the desired P_{g,F} value and ΔP_{g,F} value while the glass has a lower transition temperature. Therefore, (Li₂O+B₂O₃+Bi₂O₃)/TiO₂ is preferably 1.0 or less, more preferably 0.8 or less, even more preferably 0.5 or less, and most preferably 0.2 or less.

In this application, the inclusion of one or more components selected from Sb₂O₃, SnO₂, and CeO₂ at a content of 0-1% as the fining agent can improve the fining effect of the glass and improve the bubble degree of the glass. The content of the fining agent is preferably 0-0.5%, and more preferably 0-0.1%. Due to the reasonable design of the types and content of the components in the optical glass of this application, its bubble degree is excellent; therefore, in some embodiments, it is further preferred that no fining agent is included. When the Sb₂O₃ content exceeds 1%, the glass tends to have reduced fining performance, and its strong oxidizing effect promotes the corrosion of platinum or platinum alloy vessels used for glass melting and the deterioration of forming moulds. Therefore, the Sb₂O₃ content is preferably 0-1%, more preferably 0-0.5%, even more preferably 0-0.1%, and still even more preferably the glass is free of Sb₂O₃. SnO₂ can also be used as a fining agent, but when its content exceeds 1%, the coloring tendency of the glass increases, or when the glass is heated, softened, and re-formed by molding, Sn can become a nucleation site, leading to a tendency toward devitrification. Therefore, the SnO₂ content of the present application is preferably 0-1%, more preferably 0-0.5%, even more preferably 0-0.1%, and still even more preferably the glass is free of SnO₂. The function and content ratio of CeO₂ are the same as those of SnO₂, and the content of CeO₂ is preferably 0-1%, more preferably 0-0.5%, even more preferably 0-0.1%, and still even more preferably the glass is free of CeO₂.

Components that should not be Contained

In the glass of the present application, oxides of transition metals such as V, Cr, Mn, Fe, Co, Ni, Cu, Ag, and Mo, even if present in small amounts individually or in combination, will cause the glass to be colored and cause absorption at specific wavelengths in the visible light region, thereby weakening the property of improving visible optical transmittance of the present application. Therefore, especially for optical glass for which transmittance in the visible light region is required, it is preferable that such oxides are substantially absent.

Oxides of Th, Cd, Tl, Os, Be, and Se have, in recent years, tended to be subject to controlled use as harmful chemical substances. Environmental protection measures are necessary not only in the glass manufacturing process, but also in the processing process and the disposal after productization. Accordingly, when environmental impact is taken into consideration, it is preferable that such oxides are substantially absent, except for those unavoidably mixed in. As a result, the optical glass becomes substantially free of substances that contaminate the environment. Therefore, even without adopting special environmental protection measures, the optical glass of the present application can be manufactured, processed, and disposed of.

To achieve environmental friendliness, the optical glass of this application preferably does not include As₂O₃ and PbO.

The terms “not contain (not include, free of, or the like)” and “0%” as used herein mean that the compound, molecule, or element is not intentionally added as a raw material to the optical glass of this application; however, certain impurities or components that are not intentionally added may exist in the raw materials and/or equipment used in the production of the optical glass, and may be present in small or trace amounts in the final optical glass. This situation is also within the scope of protection of this application.

The properties of the optical glass of this application are described below.

### Refractive Index and Abbe Number

The refractive index (n_{d}) and Abbe number (ν_{d}) of the optical glass are tested according to the method specified in GB/T 7962.1-2010.

In some embodiments, the lower limit of the refractive index (n_{d}) of the optical glass of this application is 1.82, preferably 1.83, and more preferably 1.84.

In some embodiments, the upper limit of the refractive index (n_{d}) of the optical glass of this application is 1.89, preferably 1.88, and more preferably 1.87.

In some embodiments, the lower limit of the Abbe number (ν_{d}) of the optical glass of this application is 18, preferably 20, and more preferably 21.

In some embodiments, the upper limit of the Abbe number (ν_{d}) of the optical glass of this application is 26, preferably 25, and more preferably 24.

### Coefficient of Thermal Expansion

The coefficient of thermal expansion (α_{100/300° C.}) of the optical glass is tested within the temperature range of 100-300° C. according to the method specified in GB/T 7962.16-2010.

In some embodiments, the coefficient of thermal expansion (α_{100/300° C.}) of the optical glass of this application is 100×10⁻⁷/K or less, preferably 95×10⁻⁷/K or less, and more preferably 90×10⁻⁷/K or less.

### Acid Resistance Durability

The acid resistance durability (D_{A}) of the optical glass (powder method) is tested according to the method specified in GB/T 17129.

In some embodiments, the acid resistance durability (D_{A}) of the optical glass of the present application is class 2 or better, preferably class 1.

### Water Resistance Durability

The water resistance durability (D_{W}) of the optical glass (powder method) is tested according to the method specified in GB/T 17129.

In some embodiments, the water resistance durability (D_{W}) of the optical glass of the present application is class 2 or better, preferably class 1.

### Relative Partial Dispersion and Anomalous Partial Dispersion Value

The origin of relative partial dispersion (P_{g,F}) and anomalous partial dispersion value (ΔP_{g,F}) is explained by the following formulas.

The relative partial dispersion for wavelengths x and y is expressed by the following equation (1):

$${P}_{x , y} = ( {n}_{x} - {n}_{y} ) / ( {n}_{F} - {n}_{C} ) \qquad ( 1 )$$

According to the Abbe number formula, for most so-called “normal glass” (H-K6 and F4 are selected as examples of “normal glass” below), the following equation (2) holds true:

$${P}_{x , y} = {m}_{x , y} \cdot {v}_{d} + {b}_{x , y} \qquad ( 2 )$$

This linear relationship is expressed with P_{x,y} as the ordinate and v_{d} as the abscissa, wherein m_{x,y} is the slope and b_{x,y} is the intercept.

As is well known, the correction of secondary spectrum, i.e., achieving achromatization for more than two wavelengths, requires at least one type of glass that does not conform to the aforementioned equation (2) (i.e., its P_{x,y} value deviates from the Abbe empirical formula). The deviation value is denoted by ΔP_{g,F}. Thus, each P_{x,y}−v_{d} point is shifted by an amount of ΔP_{x,y} relative to the “normal line” defined by the above equation (2). The ΔP_{x,y} value for each glass can be calculated using the following equation (3):

$${p}_{x , y} = {m}_{x , y} \cdot {v}_{d} + {b}_{x , y} + Δ {P}_{x , y} \qquad ( 3 )$$

Therefore, ΔP_{x,y} quantitatively represents the deviation characteristics of the special dispersion compared to “normal glass”.

Therefore, from the above, the calculation formulas for the relative partial dispersion (P_{g,F}) and the anomalous partial dispersion value (ΔP_{g,F}) can be derived as equations (4) and (5) below:

$${P}_{g , f} = ( {n}_{g} - {n}_{F} ) / ( {n}_{F} - {n}_{C} ) \qquad ( 4 )$$

$$Δ {P}_{g , f} = {P}_{g , F} - 0.6457 + 0.001 \; 703 {v}_{d} \qquad ( 5 )$$

In some embodiments, the relative partial dispersion (P_{g,F}) of the optical glass in the present application is 0.58 to 0.72, preferably 0.60 to 0.68, and more preferably 0.62 to 0.65.

In some embodiments, the anomalous partial dispersion value (ΔP_{g,F}) of the optical glass in the present application is 0.08 or less, preferably 0.005 to 0.06, and more preferably 0.01 to 0.04.

### Transition Temperature

The transition temperature (T_{g}) of the optical glass is tested according to the method specified in GB/T7962.16-2010.

In some embodiments, the transition temperature (T_{g}) of the optical glass in the present application is 670° C. or less, preferably 660° C. or less, and more preferably 650° C. or less.

### Abrasion Resistance

The abrasion resistance (F_{A}) of the optical glass is the value obtained by multiplying the ratio of the wear amount of the tested sample to the wear amount (volume) of the standard sample (H-K9 glass) by 100 under completely identical conditions, expressed by the following equation:

$${F}_{A} = V / {V}_{0} \times 100 = ( W / ρ ) / ( {W}_{0} / {ρ}_{0} ) \times 100 ;$$

wherein: V—volume wear amount of the tested sample;
V₀—volume wear amount of the standard sample;
W—mass wear amount of the tested sample;
W₀—mass wear amount of the standard sample;
ρ—density of the tested sample; and
ρ₀—density of the standard sample.

In some embodiments, the lower limit of the abrasion resistance (F_{A}) of the optical glass in the present application is 250, preferably 260, and more preferably 265.

In some embodiments, the upper limit of the abrasion resistance (F_{A}) of the optical glass in the present application is 290, preferably 285, and more preferably 280.

### Density

The density (ρ) is tested according to the method specified in GB/T7962.20-2010.

In some embodiments, the density (ρ) of the optical glass in the present application is 4.00 g/cm³ or less, preferably 3.90 g/cm³ or less, and more preferably 3.80 g/cm³ or less.

### Coloration

The short-wave transmission spectral characteristics of the glass in the present application are expressed by coloration (λ₇₀ and λ₅). λ₇₀ refers to the wavelength at which the glass transmittance reaches 70%. The determination of λ₇₀ is performed using the glass having a thickness of 10±0.1 mm and having two opposite planes parallel to each other and optical polished, by measuring the spectral transmittance in the wavelength region from 280 nm to 700 nm and identifying the wavelength that exhibits 70% transmittance. The spectral transmittance, or transmittance, is a quantity expressed by the ratio Iₒᵤₜ/Iᵢₙ when light of intensity Iᵢₙ is incident perpendicularly to the surface of the glass, passes through the glass, and emerges from the other surface with intensity Iₒᵤₜ. This quantity also includes surface reflection losses at the glass surfaces. The higher the refractive index of the glass, the greater the surface reflection loss. Therefore, in high-refractive-index glass, a small λ₇₀ value indicates that the glass itself has extremely low coloration and high light transmittance.

In some embodiments, the λ₇₀ of the optical glass in the present application is 430 nm or less, preferably 420 nm or less, and more preferably 410 nm or less.

In some embodiments, the λ₅ of the optical glass in the present application is 400 nm or less, preferably 390 nm or less, and more preferably 380 nm or less.

### Climatic Resistance

The testing method for the climatic resistance (CR) of the optical glass is as follows. The sample is placed in a test chamber with a saturated water vapor environment at a relative humidity of 90%, and the temperature is alternately cycled between 4° and 50° C. every 1 hour for a total of 15 cycles. The climatic resistance category is determined based on the change in haze before and after the sample is placed in the test chamber. The climatic resistance classification is shown in Table 1.

TABLE 1

| | | | | 4 | | |
|---|---|---|---|---|---|---|
| Class | 1 | 2 | 3 | a | b | c |
| Increase in | <0.3 | 0.3-1.0 | 1.0-2.0 | 2.0-4.0 | 4.0-6.0 | ≥6.0 |
| haze ΔH(%) | | | | | | |

In some embodiments, the climatic resistance (CR) of the optical glass in the present application is class 2 or higher, preferably class 1.

### Young's Modulus

Young's modulus (E) is calculated by measuring the longitudinal wave velocity and transverse wave velocity using ultrasonic testing, and then using the following equation:

$$E = \frac{4 {G}^{2} - 3 {GV}_{T}^{2} ρ}{G - {V}_{T}^{2} ρ}$$

$$G = {V}_{s}^{2} ρ$$

Wherein: E is Young's modulus, the unit is Pa;
G is the shear modulus, the unit is Pa;
V_{T} is the transverse wave velocity, the unit is m/s;
V_{S} is the longitudinal wave velocity, the unit is m/s; and
ρ is the glass density, the unit is g/cm³.

In some embodiments, the Young's modulus (E) of the optical glass in the present application is 8000×10⁷ Pa or higher, preferably 8500×10⁷ Pa or higher, and more preferably 9000×10⁷ Pa or higher.

### Bubble Degree

The bubble degree of the optical glass is tested according to the method specified in GB/T7962.8-2010.

In some embodiments, the bubble degree of the optical glass in the present application is Grade A or better, preferably Grade A₀ or better, and more preferably Grade A₀₀.

### Manufacturing Method of Optical Glass

The manufacturing method of the optical glass of the present application is as follows. The glass of the present application is produced using conventional raw materials and processes, including but not limited to using oxides, hydroxides, complex salts (such as carbonates, nitrates, sulfates, phosphates, metaphosphates, etc.), boric acid, etc., as raw materials. After preparing the batch according to conventional methods, the prepared batch is fed into a melting furnace (such as a platinum or platinum alloy crucible) at 1050-1250° C., preferably 1100-1200° C., for melting. After fining and homogenization, a homogeneous molten glass free of bubbles and undissolved substances is obtained. This molten glass is then cast in a mold and annealed. Those skilled in the art can appropriately select the raw materials, process methods, and process parameters according to actual needs.

### Glass Preforms and Optical Elements

Glass preforms can be produced from the prepared optical glass using methods such as direct droplet forming, grinding, or press-forming methods including hot press forming. That is, glass precision preforms may be produced by directly performing precision droplet forming on molten optical glass, or glass preforms may be produced by subjecting a preform blank made of optical glass for press forming to reheating press forming followed by grinding. It should be noted that the methods for producing glass preforms are not limited to the above methods.

As described above, the optical glass of the present application is useful for various optical elements and optical designs. In particular, preform blanks formed from the optical glass of the present application are especially preferred, which can be used for reheating press forming, precision press forming, and the like to produce optical elements such as lenses and prisms.

Both the glass preforms and optical elements of the present application are formed from the optical glass of the present application. The glass preforms of the present application possess the excellent properties of the optical glass; the optical elements of the present application possess the excellent properties of the optical glass and can provide various lenses, prisms, and other optical elements with high optical value.

Examples of lenses include various lenses having spherical or aspherical surfaces, such as concave meniscus lenses, convex meniscus lenses, biconvex lenses, biconcave lenses, plano-convex lenses, and plano-concave lenses.

### Optical Instruments

The optical elements formed from the optical glass of the present application can be used to manufacture optical instruments such as photographic equipment, video equipment, projection equipment, display equipment, in-vehicle equipment, and monitoring equipment.

### Examples

### Optical Glass Examples

To further clarify and illustrate the technical solution of the present application, the following non-limiting examples are provided.

In this example, optical glass having the components shown in Tables 2-4 was obtained using the above-described method for manufacturing optical glass. In addition, the properties of each glass were measured using the test methods described in the present application, and the measurement results are shown in Tables 2-4.

TABLE 2

| | Examples (wt %) | | | | | | |
|---|---|---|---|---|---|---|---|
| | 1# | 2# | 3# | 4# | 5# | 6# | 7# |
| P₂O₅ | 21.33 | 24.26 | 32 | 30.06 | 22.53 | 23.43 | 31.25 |
| Nb₂O₅ | 40.69 | 37.1 | 43.36 | 41.66 | 45.76 | 50.74 | 43.12 |
| TiO₂ | 10.25 | 8.32 | 3.21 | 1.65 | 4.12 | 2.5 | 6.31 |
| BaO | 16.15 | 15.22 | 4.9 | 6.37 | 7.45 | 8.25 | 6.63 |
| CaO | 2.21 | 6.04 | 5.12 | 0.86 | 1.19 | 4 | 3.11 |
| MgO | 0 | 1.22 | 0 | 0 | 0 | 0 | 0 |
| SrO | 2.32 | 4.25 | 3.03 | 5.57 | 1.82 | 5.21 | 3.42 |
| ZnO | 1.12 | 0 | 0 | 0 | 0.5 | 0 | 0.25 |
| Li₂O | 0.5 | 0 | 1.24 | 0 | 0 | 0.8 | 0 |
| Na₂O | 3.25 | 2.77 | 5.74 | 11.23 | 13.05 | 4.28 | 5.33 |
| K₂O | 0 | 0.5 | 0 | 1.3 | 0 | 0.24 | 0 |
| La₂O₃ | 0 | 0 | 0 | 0 | 0.33 | 0 | 0 |
| Gd₂O₃ | 0 | 0 | 0 | 0 | 0.6 | 0 | 0 |
| Y₂O₃ | 1 | 0 | 0 | 0 | 0 | 0 | 0 |
| Yb₂O₃ | 0 | 0 | 0 | 0 | 0 | 0 | 0 |
| Lu₂O₃ | 0 | 0 | 0 | 0 | 0 | 0 | 0 |
| SiO₂ | 0.23 | 0.1 | 0 | 1 | 0.35 | 0 | 0.08 |
| B₂O₃ | 0.6 | 0 | 1.3 | 0 | 0 | 0 | 0 |
| Al₂O₃ | 0 | 0 | 0 | 0 | 0 | 0 | 0 |
| WO₃ | 0.3 | 0 | 0 | 0.2 | 0 | 0 | 0.5 |
| ZrO₂ | 0 | 0.22 | 0 | 0 | 1 | 0 | 0 |
| Bi₂O₃ | 0 | 0 | 0 | 0 | 1.3 | 0.45 | 0 |
| Sb₂O₃ | 0.05 | 0 | 0.1 | 0.1 | 0 | 0 | 0 |
| SnO₂ | 0 | 0 | 0 | 0 | 0 | 0.1 | 0 |
| CeO₂ | 0 | 0 | 0 | 0 | 0 | 0 | 0 |
| Total | 100 | 100 | 100 | 100 | 100 | 100 | 100 |
| (ZnO + Li₂O + K₂O + WO₃ + | 1.09 | 0.12 | 0.84 | 0.27 | 0.99 | 0.29 | 0.22 |
| B₂O₃ + Bi₂O₃)/SrO | | | | | | | |
| (Li₂O + B₂O₃ + Bi₂O₃)/TiO₂ | 0.11 | 0 | 0.79 | 0 | 0.32 | 0.50 | 0 |
| SrO/TiO₂ | 0.23 | 0.51 | 0.94 | 3.38 | 0.44 | 2.08 | 0.54 |
| BaO/(Na₂O + K₂O + TiO₂) | 1.20 | 1.31 | 0.55 | 0.45 | 0.43 | 1.18 | 0.57 |
| Nb₂O₅/P₂O₅ | 1.91 | 1.53 | 1.36 | 1.39 | 2.03 | 2.17 | 1.38 |
| (SiO₂ + CaO + ZnO)/SrO | 1.53 | 1.44 | 1.69 | 0.33 | 1.12 | 0.77 | 1.01 |
| (WO₃ + ZnO + K₂O + | 0.35 | 0.93 | 1.60 | 1.43 | 0.41 | 1.70 | 0.61 |
| CaO + MgO)/TiO₂ | | | | | | | |
| (WO₃ + K₂O + TiO₂ + | 0.27 | 0.24 | 0.10 | 0.08 | 0.09 | 0.05 | 0.16 |
| B₂O₃)/Nb₂O₅ | | | | | | | |
| Na₂O/BaO | 0.20 | 0.18 | 1.17 | 1.76 | 1.75 | 0.52 | 0.80 |
| BaO/P₂O₅ | 0.76 | 0.63 | 0.15 | 0.21 | 0.33 | 0.35 | 0.21 |
| (Li₂O + B₂O₃ + TiO₂)/BaO | 0.70 | 0.55 | 1.17 | 0.26 | 0.55 | 0.40 | 0.95 |
| TiO₂/CaO | 4.64 | 1.38 | 0.63 | 1.92 | 3.46 | 0.63 | 2.03 |
| n_{d} | 1.86762 | 1.83453 | 1.84336 | 1.82463 | 1.85462 | 1.87638 | 1.84638 |
| ν_{d} | 20.42 | 24.65 | 23.72 | 25.47 | 21.37 | 19.46 | 23.05 |
| α_{100/300° C.} (×10⁻⁷/K) | 96 | 93 | 97 | 95 | 92 | 91 | 85 |
| D_{A} | Class 2 | Class 2 | Class 2 | Class 2 | Class 1 | Class 1 | Class 1 |
| D_{W} | Class 1 | Class 1 | Class 2 | Class 1 | Class 1 | Class 1 | Class 1 |
| P_{g, F} | 0.6507 | 0.6485 | 0.6925 | 0.6725 | 0.6671 | 0.6537 | 0.6521 |
| ΔP_{g, F} | 0.0513 | 0.0437 | 0.0633 | 0.0546 | 0.0524 | 0.0515 | 0.0507 |
| T_{g} (° C.) | 655 | 660 | 652 | 638 | 635 | 650 | 651 |
| F_{A} | 268 | 264 | 286 | 284 | 281 | 282 | 280 |
| E (×10⁷ Pa) | 8915 | 9105 | 8637 | 8765 | 8976 | 8838 | 9032 |
| ρ (g/cm³) | 3.76 | 3.73 | 3.83 | 3.81 | 3.80 | 3.80 | 3.81 |
| λ₇₀ (nm) | 420 | 412 | 413 | 410 | 415 | 418 | 411 |
| λ₅ (nm) | 390 | 383 | 384 | 381 | 386 | 388 | 382 |
| CR | Class 1 | Class 1 | Class 1 | Class 1 | Class 1 | Class 1 | Class 1 |
| Bubble Degree (Grade) | A₀ | A₀₀ | A | A | A | A₀ | A₀ |

TABLE 3

| | Examples (wt %) | | | | | | |
|---|---|---|---|---|---|---|---|
| | 8# | 9# | 10# | 11# | 12# | 13# | 14# |
| P₂O₅ | 29.05 | 25.27 | 28.18 | 29.32 | 26.55 | 27.16 | 28.32 |
| Nb₂O₅ | 41.62 | 44.4 | 45.6 | 43.31 | 49.36 | 47.73 | 42.74 |
| TiO₂ | 7.24 | 3.56 | 4.62 | 5.33 | 5.18 | 4.23 | 5.07 |
| BaO | 8.33 | 8.32 | 10.25 | 11.42 | 9.45 | 11.84 | 12.26 |
| CaO | 2.15 | 4.25 | 1.62 | 1.55 | 2.07 | 2.83 | 1.92 |
| MgO | 0 | 0 | 0 | 0 | 0 | 0 | 0 |
| SrO | 3.12 | 2.25 | 0.83 | 0.25 | 1.22 | 0.95 | 1.36 |
| ZnO | 0 | 0.33 | 0 | 0 | 0 | 0 | 0 |
| Li₂O | 0 | 0 | 0 | 0 | 0 | 0 | 0 |
| Na₂O | 6.34 | 9.22 | 7.35 | 8.82 | 6.17 | 5.26 | 8.33 |
| K₂O | 0 | 0 | 0 | 0 | 0 | 0 | 0 |
| La₂O₃ | 1.15 | 0 | 0 | 0 | 0 | 0 | 0 |
| Gd₂O₃ | 0 | 0 | 0 | 0 | 0 | 0 | 0 |
| Y₂O₃ | 0 | 0.6 | 0 | 0 | 0 | 0 | 0 |
| Yb₂O₃ | 0 | 0 | 0 | 0 | 0 | 0 | 0 |
| Lu₂O₃ | 0 | 0 | 0 | 0 | 0 | 0 | 0 |
| SiO₂ | 0 | 1 | 0 | 0 | 0 | 0 | 0 |
| B₂O₃ | 0 | 0.25 | 0 | 0 | 0 | 0 | 0 |
| Al₂O₃ | 0 | 0.55 | 1 | 0 | 0 | 0 | 0 |
| WO₃ | 0 | 0 | 0 | 0 | 0 | 0 | 0 |
| ZrO₂ | 0 | 0 | 0.5 | 0 | 0 | 0 | 0 |
| Bi₂O₃ | 0.8 | 0 | 0 | 0 | 0 | 0 | 0 |
| Sb₂O₃ | 0 | 0 | 0 | 0 | 0 | 0 | 0 |
| SnO₂ | 0.2 | 0 | 0.05 | 0 | 0 | 0 | 0 |
| CeO₂ | 0 | 0 | 0 | 0 | 0 | 0 | 0 |
| Total | 100 | 100 | 100 | 100 | 100 | 100 | 100 |
| (ZnO + Li₂O + K₂O + WO₃ + | 0.26 | 0.26 | 0 | 0 | 0 | 0 | 0 |
| B₂O₃ + Bi₂O₃)/SrO | | | | | | | |
| (Li₂O + B₂O₃ + Bi₂O₃)/TiO₂ | 0.11 | 0.07 | 0 | 0 | 0 | 0 | 0 |
| SrO/TiO₂ | 0.43 | 0.63 | 0.18 | 0.05 | 0.24 | 0.22 | 0.27 |
| BaO/(Na₂O + K₂O + TiO₂) | 0.61 | 0.65 | 0.86 | 0.81 | 0.83 | 1.25 | 0.91 |
| Nb₂O₅/P₂O₅ | 1.43 | 1.76 | 1.62 | 1.48 | 1.86 | 1.76 | 1.51 |
| (SiO₂ + CaO + ZnO)/SrO | 0.69 | 2.48 | 1.95 | 6.20 | 1.70 | 2.98 | 1.41 |
| (WO₃ + ZnO + K₂O + | 0.30 | 1.29 | 0.35 | 0.29 | 0.40 | 0.67 | 0.38 |
| CaO + MgO)/TiO₂ | | | | | | | |
| (WO₃ + K₂O + TiO₂ + | 0.17 | 0.09 | 0.10 | 0.12 | 0.10 | 0.09 | 0.12 |
| B₂O₃)/Nb₂O₅ | | | | | | | |
| Na₂O/BaO | 0.76 | 1.11 | 0.72 | 0.77 | 0.65 | 0.44 | 0.68 |
| BaO/P₂O₅ | 0.29 | 0.33 | 0.36 | 0.39 | 0.36 | 0.44 | 0.43 |
| (Li₂O + B₂O₃ + TiO₂)/BaO | 0.87 | 0.46 | 0.45 | 0.47 | 0.55 | 0.36 | 0.41 |
| TiO₂/CaO | 3.37 | 0.84 | 2.85 | 3.44 | 2.50 | 1.49 | 2.64 |
| n_{d} | 1.84368 | 1.83854 | 1.85862 | 1.85063 | 1.88435 | 1.86348 | 1.85164 |
| ν_{d} | 22.75 | 23.46 | 22.57 | 23.16 | 18.52 | 21.47 | 22.95 |
| α_{100/300° C.} (×10⁻⁷/K) | 87 | 91 | 86 | 85 | 87 | 85 | 83 |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| P_{g, F} | 0.6522 | 0.6214 | 0.6238 | 0.6082 | 0.6308 | 0.6325 | 0.6275 |
| ΔP_{g, F} | 0.0513 | 0.0175 | 0.0204 | 0.0136 | 0.0247 | 0.0236 | 0.0213 |
| T_{g} (° C.) | 645 | 640 | 643 | 641 | 642 | 648 | 642 |
| F_{A} | 273 | 281 | 268 | 270 | 272 | 274 | 270 |
| E (×10⁷ Pa) | 9052 | 9065 | 9210 | 9083 | 9124 | 9113 | 9227 |
| ρ (g/cm³) | 3.77 | 3.81 | 3.75 | 3.83 | 3.72 | 3.81 | 3.70 |
| λ₇₀ (nm) | 408 | 407 | 403 | 400 | 402 | 405 | 404 |
| λ₅ (nm) | 380 | 378 | 375 | 370 | 371 | 375 | 375 |
| CR | Class 1 | Class 1 | Class 1 | Class 1 | Class 1 | Class 1 | Class 1 |
| Bubble Degree (Grade) | A₀₀ | A₀ | A₀₀ | A₀₀ | A₀₀ | A₀₀ | A₀₀ |

TABLE 4

| | Examples (wt %) | | | | | | |
|---|---|---|---|---|---|---|---|
| | 15# | 16# | 17# | 18# | 19# | 20# | 21# |
| P₂O₅ | 29.14 | 27.25 | 27.12 | 27.37 | 26.36 | 28.14 | 27.51 |
| Nb₂O₅ | 42.97 | 40.86 | 44.15 | 43.68 | 46.09 | 44.74 | 48.1 |
| TiO₂ | 6.25 | 4.14 | 4.72 | 5.11 | 6.06 | 7.12 | 5.21 |
| BaO | 10.43 | 14.05 | 13.32 | 12.43 | 11.76 | 7.24 | 8.23 |
| CaO | 1.73 | 2.54 | 2.01 | 1.88 | 1.35 | 2.26 | 1.64 |
| MgO | 0 | 0 | 0 | 0 | 0 | 0 | 0 |
| SrO | 2.24 | 2.13 | 1.25 | 1.47 | 1.06 | 1.38 | 1.53 |
| ZnO | 0 | 0 | 0 | 0 | 0 | 0 | 0 |
| Li₂O | 0 | 0 | 0 | 0 | 0 | 0 | 0 |
| Na₂O | 7.24 | 9.03 | 7.43 | 8.06 | 7.32 | 9.12 | 7.78 |
| K₂O | 0 | 0 | 0 | 0 | 0 | 0 | 0 |
| La₂O₃ | 0 | 0 | 0 | 0 | 0 | 0 | 0 |
| Gd₂O₃ | 0 | 0 | 0 | 0 | 0 | 0 | 0 |
| Y₂O₃ | 0 | 0 | 0 | 0 | 0 | 0 | 0 |
| Yb₂O₃ | 0 | 0 | 0 | 0 | 0 | 0 | 0 |
| Lu₂O₃ | 0 | 0 | 0 | 0 | 0 | 0 | 0 |
| SiO₂ | 0 | 0 | 0 | 0 | 0 | 0 | 0 |
| B₂O₃ | 0 | 0 | 0 | 0 | 0 | 0 | 0 |
| Al₂O₃ | 0 | 0 | 0 | 0 | 0 | 0 | 0 |
| WO₃ | 0 | 0 | 0 | 0 | 0 | 0 | 0 |
| ZrO₂ | 0 | 0 | 0 | 0 | 0 | 0 | 0 |
| Bi₂O₃ | 0 | 0 | 0 | 0 | 0 | 0 | 0 |
| Sb₂O₃ | 0 | 0 | 0 | 0 | 0 | 0 | 0 |
| SnO₂ | 0 | 0 | 0 | 0 | 0 | 0 | 0 |
| CeO₂ | 0 | 0 | 0 | 0 | 0 | 0 | 0 |
| Total | 100 | 100 | 100 | 100 | 100 | 100 | 100 |
| (ZnO + Li₂O + K₂O + WO₃ + | 0 | 0 | 0 | 0 | 0 | 0 | 0 |
| B₂O₃ + Bi₂O₃)/SrO | | | | | | | |
| (Li₂O + B₂O₃ + Bi₂O₃)/TiO₂ | 0 | 0 | 0 | 0 | 0 | 0 | 0 |
| SrO/TiO₂ | 0.36 | 0.51 | 0.26 | 0.29 | 0.17 | 0.19 | 0.29 |
| BaO/(Na₂O + K₂O + TiO₂) | 0.77 | 1.07 | 1.10 | 0.94 | 0.88 | 0.45 | 0.63 |
| Nb₂O₅/P₂O₅ | 1.47 | 1.50 | 1.63 | 1.60 | 1.75 | 1.59 | 1.75 |
| (SiO₂ + CaO + ZnO)/SrO | 0.77 | 1.19 | 1.61 | 1.28 | 1.27 | 1.64 | 1.07 |
| (WO₃ + ZnO + K₂O + | 0.28 | 0.61 | 0.43 | 0.37 | 0.22 | 0.32 | 0.31 |
| CaO + MgO)/TiO₂ | | | | | | | |
| (WO₃ + K₂O + TiO₂ + | 0.15 | 0.10 | 0.11 | 0.12 | 0.13 | 0.16 | 0.11 |
| B₂O₃)/Nb₂O₅ | | | | | | | |
| Na₂O/BaO | 0.69 | 0.64 | 0.56 | 0.65 | 0.62 | 1.26 | 0.95 |
| BaO/P₂O₅ | 0.36 | 0.52 | 0.49 | 0.45 | 0.45 | 0.26 | 0.30 |
| (Li₂O + B₂O₃ + TiO₂)/BaO | 0.60 | 0.29 | 0.35 | 0.41 | 0.52 | 0.98 | 0.63 |
| TiO₂/CaO | 3.61 | 1.63 | 2.35 | 2.72 | 4.49 | 3.15 | 3.18 |
| n_{d} | 1.85834 | 1.83375 | 1.85635 | 1.85762 | 1.85835 | 1.86124 | 1.86284 |
| ν_{d} | 22.06 | 23.85 | 22.42 | 22.36 | 22.34 | 22.73 | 21.46 |
| α_{100/300° C.} (×10⁻⁷/K) | 86 | 88 | 85 | 84 | 86 | 90 | 84 |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| P_{g, F} | 0.6501 | 0.6324 | 0.6317 | 0.6285 | 0.6411 | 0.6427 | 0.6408 |
| ΔP_{g, F} | 0.0411 | 0.0252 | 0.0238 | 0.0223 | 0.0317 | 0.0326 | 0.0304 |
| T_{g} (° C.) | 646 | 644 | 645 | 642 | 641 | 640 | 647 |
| F_{A} | 274 | 273 | 272 | 275 | 271 | 280 | 275 |
| E (×10⁷ Pa) | 9075 | 9120 | 9235 | 9110 | 9108 | 9173 | 9125 |
| ρ (g/cm³) | 3.72 | 3.72 | 3.75 | 3.74 | 3.72 | 3.75 | 3.74 |
| λ₇₀ (nm) | 406 | 405 | 402 | 401 | 404 | 410 | 405 |
| λ₅ (nm) | 376 | 373 | 373 | 371 | 372 | 380 | 374 |
| CR | Class 1 | Class 1 | Class 1 | Class 1 | Class 1 | Class 1 | Class 1 |
| Bubble Degree (Grade) | A₀₀ | A₀₀ | A₀₀ | A₀₀ | A₀₀ | A₀ | A₀₀ |

### Glass Preform Examples

The glass obtained from Examples 1-21 of the optical glass is processed by methods such as grinding, or by press-forming methods including reheating press forming and precision press forming, to produce preforms of various lenses, prisms, and the like, such as concave meniscus lenses, convex meniscus lenses, biconvex lenses, biconcave lenses, plano-convex lenses, and plano-concave lenses.

### Optical Element Examples

The preforms obtained in above glass preform examples are annealed to reduce internal stress in the glass while fine-tuning the refractive index, such that the refractive index and other optical properties reach the desired values.

Subsequently, each preform is subjected to grinding and polishing to produce various lenses and prisms, such as concave meniscus lenses, convex meniscus lenses, biconvex lenses, biconcave lenses, plano-convex lenses, and plano-concave lenses. An antireflection coating may further be applied to surfaces of the obtained optical elements.

### Optical Instrument Examples

The optical elements obtained in above optical element examples are optically designed and combined by using one or more optical elements to form optical parts or optical assemblies, which can be used, for example, in imaging devices, sensors, microscopes, medical technology, digital projection, communications, optical communication technology/information transmission, optics/lighting in the automotive field, photolithography, excimer lasers, wafers, computer chips, and integrated circuits and electronic devices including such circuits and chips.

What is claimed is:

1. An optical glass, comprising following components in percentage by weight:
P₂O₅: 20-35%;
Nb₂O₅: 37-55%;
TiO₂: 1-12%;
BaO: 4-19%; and
Na₂O: 0.5-14%.

2. The optical glass according to claim 1, further comprising following components in percentage by weight: CaO: 0-8%; and/or MgO: 0-5%; and/or SrO: 0-8%; and/or ZnO: 0-5%; and/or Li₂O: 0-5%; and/or K₂O: 0-5%; and/or Ln₂O₃: 0-5%; and/or SiO₂: 0-5%; and/or B₂O₃: 0-5%; and/or Al₂O₃: 0-3%; and/or WO₃: 0-3%; and/or ZrO₂: 0-5%; and/or Bi₂O₃: 0-3%; and/or a fining agent: 0-1%,
wherein Ln₂O₃ is one or more of La₂O₃, Gd₂O₃, Y₂O₃, Yb₂O₃, and Lu₂O₃, and the fining agent is one or more of Sb₂O₃, SnO₂, and CeO₂.

3. The optical glass according to claim 1, the components expressed in percentage by weight, satisfying one or more of following 12 conditions:
(1) (ZnO+Li₂O+K₂O+WO₃+B₂O₃+Bi₂O₃)/SrO being 2.0 or less;
(2) (Li₂O+B₂O₃+Bi₂O₃)/TiO₂ being 1.0 or less;
(3) SrO/TiO₂ being 0.01 to 5.0;
(4) BaO/(Na₂O+K₂O+TiO₂) being 0.4 to 5.0;
(5) Nb₂O₅/P₂O₅ being 1.3 to 2.7;
(6) (SiO₂+CaO+ZnO)/SrO being 0.3 to 8.0;
(7) (WO₃+ZnO+K₂O+CaO+MgO)/TiO₂ being 2.0 or less;
(8) (WO₃+K₂O+TiO₂+B₂O₃)/Nb₂O₅ being 0.03 to 0.4;
(9) Na₂O/BaO being 0.05 to 2.0;
(10) BaO/P₂O₅ being 0.15 to 0.9;
(11) (Li₂O+B₂O₃+TiO₂)/BaO being 0.06 to 2.0; and
(12) TiO₂/CaO being 0.4 to 10.0.

4. The optical glass according to claim 1, the components expressed in percentage by weight, satisfying one or more of following 12 conditions:
(1) (ZnO+Li₂O+K₂O+WO₃+B₂O₃+Bi₂O₃)/SrO being 1.5 or less;
(2) (Li₂O+B₂O₃+Bi₂O₃)/TiO₂ being 0.8 or less;
(3) SrO/TiO₂ being 0.01 to 2.0;
(4) BaO/(Na₂O+K₂O+TiO₂) being 0.5 to 3.0;
(5) Nb₂O₅/P₂O₅ being 1.4 to 2.5;
(6) (SiO₂+CaO+ZnO)/SrO being 0.5 to 5.0;
(7) (WO₃+ZnO+K₂O+CaO+MgO)/TiO₂ being 0.05 to 1.5;
(8) (WO₃+K₂O+TiO₂+B₂O₃)/Nb₂O₅ being 0.04 to 0.3;
(9) Na₂O/BaO being 0.1 to 1.5;
(10) BaO/P₂O₅ being 0.25 to 0.8;
(11) (Li₂O+B₂O₃+TiO₂)/BaO being 0.07 to 1.5; and
(12) TiO₂/CaO being 0.8 to 8.0.

5. The optical glass according to claim 1, the components expressed in percentage by weight, satisfying one or more of following 12 conditions:
(1) (ZnO+Li₂O+K₂O+WO₃+B₂O₃+Bi₂O₃)/SrO being 1.0 or less;
(2) (Li₂O+B₂O₃+Bi₂O₃)/TiO₂ being 0.5 or less;
(3) SrO/TiO₂ being 0.05 to 1.0;
(4) BaO/(Na₂O+K₂O+TiO₂) being 0.6 to 2.5;
(5) Nb₂O₅/P₂O₅ being 1.5 to 2.2;
(6) (SiO₂+CaO+ZnO)/SrO being 0.6 to 3.0;
(7) (WO₃+ZnO+K₂O+CaO+MgO)/TiO₂ being 0.1 to 1.0;
(8) (WO₃+K₂O+TiO₂+B₂O₃)/Nb₂O₅ being 0.05 to 0.25;
(9) Na₂O/BaO being 0.2 to 1.0;
(10) BaO/P₂O₅ being 0.3 to 0.7;
(11) (Li₂O+B₂O₃+TiO₂)/BaO being 0.08 to 1.0; and
(12) TiO₂/CaO being 1.0 to 6.0.

6. The optical glass according to claim 1, the components expressed in percentage by weight, satisfying one or more of following 12 conditions:
(1) (ZnO+Li₂O+K₂O+WO₃+B₂O₃+Bi₂O₃)/SrO being 0.5 or less;
(2) (Li₂O+B₂O₃+Bi₂O₃)/TiO₂ being 0.2 or less;
(3) SrO/TiO₂ being 0.1 to 0.7;
(4) BaO/(Na₂O+K₂O+TiO₂) being 0.7 to 1.5;
(5) Nb₂O₅/P₂O₅ being 1.6 to 2.0;
(6) (SiO₂+CaO+ZnO)/SrO being 0.7 to 2.0;
(7) (WO₃+ZnO+K₂O+CaO+MgO)/TiO₂ being 0.2 to 0.8;
(8) (WO₃+K₂O+TiO₂+B₂O₃)/Nb₂O₅ being 0.06 to 0.15;
(9) Na₂O/BaO being 0.4 to 0.9;
(10) BaO/P₂O₅ being 0.35 to 0.6;
(11) (Li₂O+B₂O₃+TiO₂)/BaO being 0.1 to 0.5; and
(12) TiO₂/CaO being 1.2 to 5.0.

7. The optical glass according to claim 1, the components expressed in percentage by weight, comprising: P₂O₅: 22-32%; and/or Nb₂O₅: 41-52%; and/or TiO₂: 2-10%; and/or BaO: 6-16.5%; and/or Na₂O: 2-12%; and/or CaO: greater than 0 but less than or equal to 6%; and/or MgO: 0-3%; and/or SrO: greater than 0 but less than or equal to 5%; and/or ZnO: 0-3%; and/or Li₂O: 0-3%; and/or K₂O: 0-3%; and/or Ln₂O₃: 0-3%; and/or SiO₂: 0-3%; and/or B₂O₃: 0-3%; and/or Al₂O₃: 0-2%; and/or WO₃: 0-2%; and/or ZrO₂: 0-2%; and/or Bi₂O₃: 0-2%; and/or a fining agent: 0-0.5%, wherein Ln₂O₃ is one or more of La₂O₃, Gd₂O₃, Y₂O₃, Yb₂O₃, and Lu₂O₃, and the fining agent is one or more of Sb₂O₃, SnO₂, and CeO₂.

8. The optical glass according to claim 1, the components expressed in percentage by weight, comprising: P₂O₅: 25-30%; and/or Nb₂O₅: 43-50%; and/or TiO₂: 3-7%; and/or BaO: 10-15%; and/or Na₂O: 5-10%; and/or CaO: 1-4%; and/or MgO: 0-1%; and/or SrO: 0.5-3%; and/or ZnO: 0-1%; and/or Li₂O: 0-10%; and/or K₂O: 0-10%; and/or Ln₂O₃: 0-1%; and/or SiO₂: 0-10%; and/or B₂O₃: 0-1%; and/or Al₂O₃: 0-1%; and/or WO₃: 0-1%; and/or ZrO₂: 0-1%; and/or Bi₂O₃: 0-1%; and/or a fining agent: 0-0.1%, wherein Ln₂O₃ is one or more of La₂O₃, Gd₂O₃, Y₂O₃, Yb₂O₃, and Lu₂O₃, and the fining agent is one or more of Sb₂O₃, SnO₂, and CeO₂.

9. The optical glass according to claim 1, not comprising MgO; and/or not comprising ZnO; not comprising Li₂O; and/or not comprising K₂O; and/or not comprising Ln₂O₃; and/or not comprising B₂O₃; and/or not comprising Al₂O₃; and/or not comprising WO₃; and/or not comprising ZrO₂; and/or not comprising Bi₂O₃; and/or not comprising a fining agent, wherein Ln₂O₃ is one or more of La₂O₃, Gd₂O₃, Y₂O₃, Yb₂O₃, and Lu₂O₃, and the clarifying agent is one or more of Sb₂O₃, SnO₂, and CeO₂.

10. The optical glass according to claim 1, wherein a refractive index n_{d} of the optical glass is 1.82 to 1.89; and an Abbe number ν_{d} is 18 to 26.

11. The optical glass according to claim 1, wherein a refractive index n_{d} of the optical glass is 1.83 to 1.88; and an Abbe number ν_{d} is 20 to 25.

12. The optical glass according to claim 1, wherein a refractive index n_{d} of the optical glass is 1.84 to 1.87; and an Abbe number ν_{d} is 21 to 24.

13. The optical glass according to claim 1, wherein
a coefficient of thermal expansion α_{100/300° C.} of the optical glass is 100×10⁻⁷/K or less; and/or
an acid resistance durability D_{A} is class 2 or better; and/or
a water resistance durability D_{W} is class 2 or better; and/or
a relative partial dispersion P_{g,F} is 0.58 to 0.72; and/or
an anomalous partial dispersion value ΔP_{g,F} is 0.08 or less; and/or
a transition temperature T_{g} is 670° C. or less; and/or
an abrasion resistance F_{A} is 250 to 290; and/or
a density ρ is 4.00 g/cm³ or less; and/or
λ₇₀ is 430 nm or less; and/or
λ₅ is 400 nm or less; and/or
a climatic resistance CR is class 2 or better; and/or
a Young's modulus E is 8000×10⁷ Pa or higher; and/or
a bubble degree is Grade A or better.

14. The optical glass according to claim 1, wherein
a coefficient of thermal expansion α_{100/300° C.} of the optical glass is 95×10⁻⁷/K or less; and/or
an acid resistance durability D_{A} is Class 1; and/or
a water resistance durability D_{W} is Class 1; and/or
a relative partial dispersion P_{g,F} is 0.60 to 0.68; and/or
an anomalous partial dispersion value ΔP_{g,F} is 0.005 to 0.06; and/or
a transition temperature T_{g} is 660° C. or less; and/or
an abrasion resistance F_{A} is 260 to 285; and/or
a density ρ is 3.90 g/cm³ or less; and/or
λ₇₀ is 420 nm or less; and/or
λ₅ is 390 nm or less; and/or
a climatic resistance CR is Class 1; and/or
a Young's modulus E is 8500×10⁷ Pa or more; and/or
a bubble degree is Grade A₀ or better.

15. The optical glass according to claim 1, wherein
a coefficient of thermal expansion α_{100/300° C.} of the optical glass is 90×10⁻⁷/K or less; and/or
a relative partial dispersion P_{g,F} is 0.62 to 0.65; and/or
an anomalous partial dispersion value ΔP_{g,F} is 0.01 to 0.04; and/or
a transition temperature T_{g} is 650° C. or less; and/or
an abrasion resistance F_{A} is 265 to 280; and/or
a density ρ is 3.80 g/cm³ or less; and/or
λ₇₀ is 410 nm or less; and/or
λ₅ is 380 nm or less; and/or
a Young's modulus E is 9000×10⁷ Pa or more; and/or
a bubble degree is Grade A₀₀.

16. An optical element, wherein the optical element is made of the optical glass according to claim 1.

17. An optical instrument, comprising the optical glass according to claim 1.
